(19) United States
(12) Patent Application Publication
(10) Pub. No.: US 2025/0289122 A1
(43) Pub. Date: Sep. 18, 2025

(54) TECHNIQUES FOR ROBOT CONTROL USING STUDENT ACTOR MODELS

(71) Applicant: NVIDIA CORPORATION, Santa Clara, CA (US)

(72) Inventors: Iretiayo AKINOLA, Seattle, WA (US); Jan CARIUS, Zurich (CH); Dieter FOX, Seattle, WA (US); Yashraj Shyam NARANG, Seattle, WA (US); Jie XU, Bellevue, WA (US)

(21) Appl. No.: 18/940,682

(22) Filed: Nov. 7, 2024

Related U.S. Application Data
(60) Provisional application No. 63/565,494, filed on Mar. 14, 2024.

(51) Int. Cl. B25J 9/16; B25J 13/08

(52) U.S. Cl. CPC B25J 9/163; B25J 9/1653; B25J 13/08

(57) ABSTRACT

Techniques for training a machine learning model to control a robot include performing, based on a first set of data, one or more training operations to generate a first trained machine learning model to control a robot and a trained evaluation model, and performing, based on a second set of data and first feedback generated by the trained evaluation model, one or more training operations to generate a second trained machine learning model to control the robot, where the second set of data is associated with a different set of sensor modalities than the first set of data.

### CROSS-REFERENCE TO RELATED APPLICATIONS

This application claims priority benefit of the United States Provisional Patent Application titled, “ACCELERATED HIGH-DIMENSIONAL REINFORCEMENT LEARNING USING PRETRAINED CRITIC,” filed on Mar. 14, 2024, and having Ser. No. 63/565,494. The subject matter of this related application is hereby incorporated herein by reference.

### BACKGROUND

### Technical Field

The embodiments of the present disclosure relate generally to robot control, machine learning, and artificial intelligence, and more specifically, to techniques for robot control using student actor models.

### Description of the Related Art

Robot control systems are used in many industries to enable precise and automated operations, improving efficiency and reducing human intervention in various tasks. In particular, robot control systems are oftentimes employed in manufacturing, autonomous vehicles, healthcare, and other applications where robots can be controlled to perform tasks with high accuracy and repeatability. For example, in manufacturing, robot arms controlled by robot control systems can handle tasks, such as welding, assembly, material handling, and/or the like, ensuring consistent quality and speed in production lines.

One conventional approach for robot control is to train a machine learning model to control a robot using reinforcement learning (RL). RL allows robots to autonomously explore different robot control strategies by trial and error, optimizing robot actions based on feedback from the environment in the form of rewards or penalties. In an RL framework, a policy refers to the control strategy used by a robot, which determines the actions the robot takes in response to the current state of the robot and/or the environment. The robot operates within the environment, taking actions and adjusting the policy based on the feedback the robot receives, enabling the robot to improve robot behavior over time and achieve better outcomes. The feedback informs the robot on how to adjust the behavior to achieve better outcomes over time. A widely employed approach within RL is the actor-critic framework, which utilizes two machine learning models: an actor model that is responsible for selecting actions for a robot to perform, and a critic model that evaluates the actions by estimating future rewards. In the actor-critic framework, the actor model is trained to refine the decision-making by the actor model while receiving feedback from the critic model. For example, in a robotic grasping task, the actor model could decide how the robot should position a gripper based on sensor inputs, while the critic model could evaluate whether each action to re-position the gripper is likely to result in a successful grasp based on past experience.

One drawback of conventional robot control approaches is that conventional robot control approaches perform poorly with increasing size of input data. As the robot receives more detailed information from sensors, such as visual, tactile, and position data, the conventional robot control approaches have to process a larger amount of data to control the robot. The increase in the size and complexity of the data—sometimes referred to as high dimensionality—limits the capability of the conventional robot control approaches to learn how to control the robot to perform a task quickly. As a result, the learning process can become slower, and the trained robot may not perform as desired. For example, in a visuotactile robot control system, where a robot relies on both visual and tactile data to interact with the environment, the input space becomes large due to the combination of detailed data from visual images, which include many pixels, and tactile sensor readings, as well as other inputs, such as joint positions. Visual images contribute mainly to the increase in data size because visual images include more individual data points (e.g., pixels) compared to simpler inputs, such as joint positions and/or the like.

The increase in dimensionality can overwhelm the actor and critic models and prevent conventional RL approaches from effectively training the actor and critic models to correctly control a robot. As a result, the robot being controlled by the actor model could struggle to make precise movements, such as handling delicate objects or performing fine manipulation tasks. Managing large amounts of input data also requires more computational resources, which can result in slower progress in improving the robot control strategy during training using conventional RL approaches. Additionally, the increased dimensionality can lead to overfitting, where the actor model learns during training to perform well on specific training data but fails to generalize to new scenarios after the actor model is trained.

As the foregoing illustrates, what is needed in the art are more effective techniques for robot control.

### SUMMARY

One embodiment of the present disclosure sets forth a computer-implemented method for training a machine learning model to control a robot. The method includes performing, based on a first set of data, one or more training operations to generate a first trained machine learning model to control a robot and a trained evaluation model. The method further includes performing, based on a second set of data and first feedback generated by the trained evaluation model, one or more training operations to generate a second trained machine learning model to control the robot, where the second set of data is associated with a different set of sensor modalities than the first set of data.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to prior art is that, with the disclosed techniques, robots can be effectively controlled based on high-dimensional data from various sources, such as visual, tactile, and/or position data. Another advantage of the disclosed techniques is that using reinforcement learning approaches, such as the Proximal Policy Optimization (PPO) technique, and using the privileged data from a simulator, the disclosed techniques enable faster training of machine learning models to control robots. These technical advantages provide one or more technological improvements over prior art approaches.

### BRIEF DESCRIPTION OF THE DRAWINGS

So that the manner in which the above recited features of the various embodiments can be understood in detail, a more particular. description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3A is a more detailed illustration of the model trainer of FIG. 1 training an expert critic model and an expert actor model, according to various embodiments;

FIG. 3B is a more detailed illustration of the model trainer of FIG. 1 retraining the expert critic model and training a student actor model, according to various embodiments;

FIG. 4 is a more detailed illustration of the robot control application of FIG. 1, according to various embodiments;

FIG. 5 sets forth a flow diagram of method steps for training a student actor model, according to various embodiments;

FIG. 6 sets forth a flow diagram of method steps for training an expert critic model and an expert actor model, according to various embodiments;

FIG. 7 sets forth a flow diagram of method steps for training a student actor model and retraining an expert critic model, according to various embodiments; and

FIG. 8 sets forth a flow diagram of method steps for controlling a robot using the trained student actor model, according to various embodiments.

### DETAILED DESCRIPTION

In the following description, numerous specific details are set forth to provide a more thorough understanding of the embodiments of the present invention. However, it will be apparent to one of skill in the art that the embodiments of the present invention may be practiced without one or more of these specific details.

### General Overview

Embodiments of the present disclosure provide techniques for robot control using student actor models that are trained with pre-trained critic models. The disclosed techniques include training a student actor model using an actor-critic reinforcement learning framework in a two-stage process. In the first stage, an expert actor model and an expert critic model are trained using privileged data, such as exact object positions, forces, velocities, contact points, and/or the like, from a simulator. The expert actor model is a machine learning model that processes privileged data to generate robot actions, while the expert critic model evaluates the actions and provides feedback to improve the actions generated by the expert actor model. Once the expert critic model and the expert actor models are trained, the student actor model, which is another machine learning model that processes sensor data, such as visual inputs from cameras, tactile data from touch sensors, and/or the like, and generates robot actions, is trained using simulated sensor data and feedback from the expert critic model. The disclosed techniques also include an option to retrain the expert critic model during training of the student actor model training. After training, the student actor model can be deployed to control a robot by processing real-world sensor inputs and generating robot actions to perform tasks.

The robot control techniques of the present disclosure have many real-world applications. For example, the robot control techniques could be used to control a physical robot in a real-world environment or a simulated robot in a virtual environment. As another example, the robot control techniques could be used to control other characters having movable joints like a robot.

The above examples are not in any way intended to be limiting. As persons skilled in the art will appreciate, as a general matter, the robot control techniques described herein can be implemented in any suitable application.

### System Overview

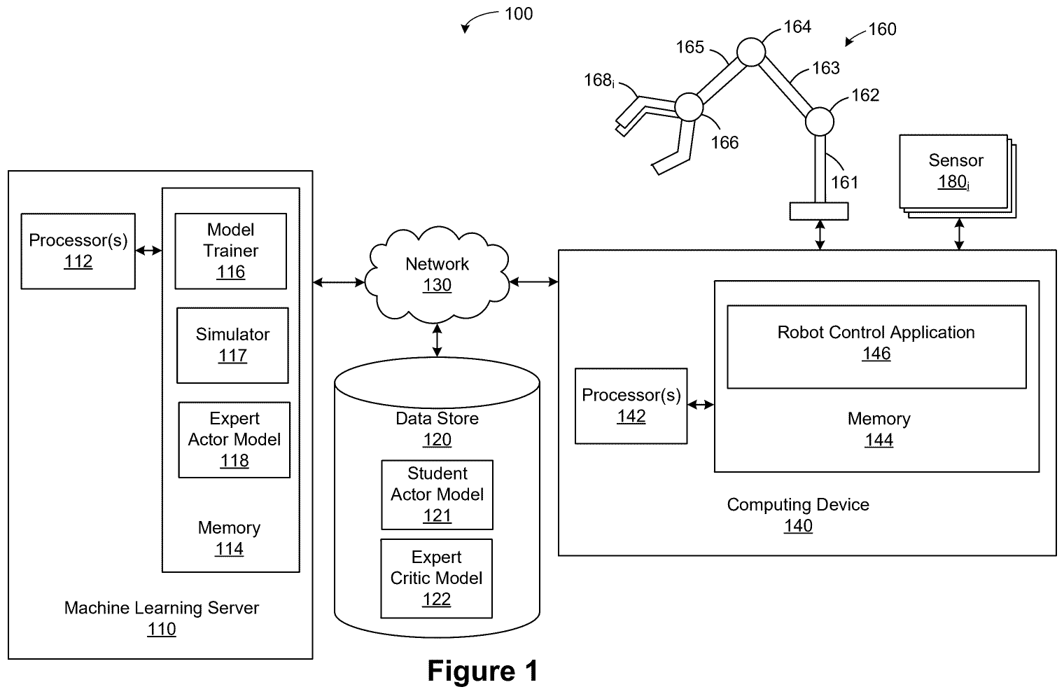

FIG. 1 illustrates a block diagram of a computer-based system configured to implement one or more aspects of the various embodiments. As shown, the system 100 includes a machine learning server 110, a data store 120, and a computing device 140 in communication over a network 130, which can be a wide area network (WAN) such as the Internet, a local area network (LAN), and/or any other suitable network. Machine learning server 110 includes, without limitation, processor(s) 112 and a memory 114. Memory 114 includes, without limitation, a model trainer 116, a simulator 117, and an expert actor model 118. Data store 120 includes, without limitation, a student actor model 121 and an expert critic model 122. Critic models are also referred to herein as “evaluation models.” Computing device 140 includes, without limitation, processor(s) 142 and a memory 144. Memory 144 includes, without limitation, a robot control application 146.

As shown, model trainer 116 executes on one or more processors 112 of the machine learning server 110 and is stored in a system memory 114 of the machine learning server 110. The processor(s) 112 receive user input from input devices, such as a keyboard or a mouse. In operation, the one or more processors 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random access memory (RAM), a read-only memory (ROM), an erasable programmable read-only memory (EPROM or Flash ROM), or any suitable combination of the foregoing. In at least one embodiment, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In at least one embodiment, any combination of the processor(s) 112, the system memory 114, and/or a GPU(s) can be included in and/or replaced with any type of virtual computing system, distributed computing system, and/or cloud computing environment, such as a public, private, or a hybrid cloud system. As shown, machine learning server 110 includes, without limitation, model trainer 116, simulator 117, and expert actor model 118.

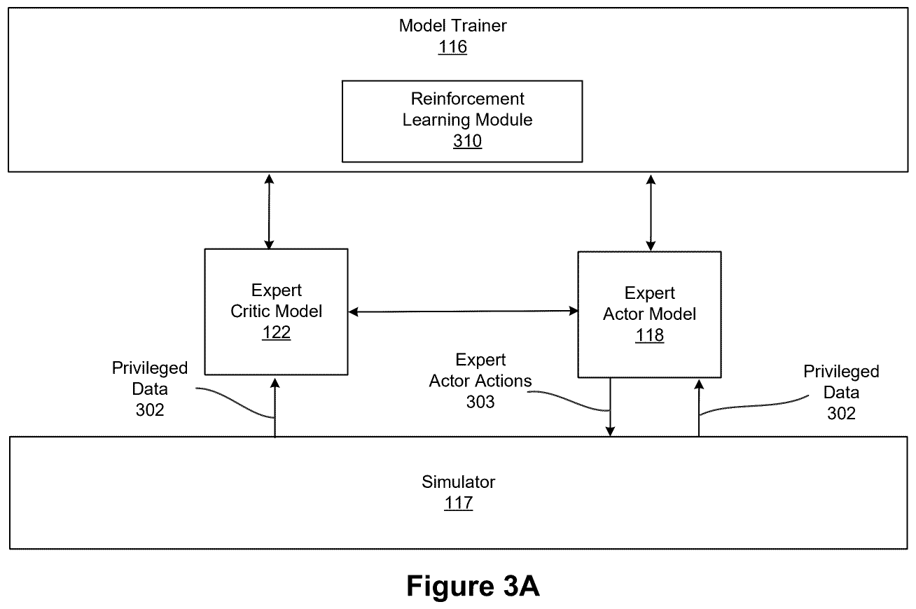

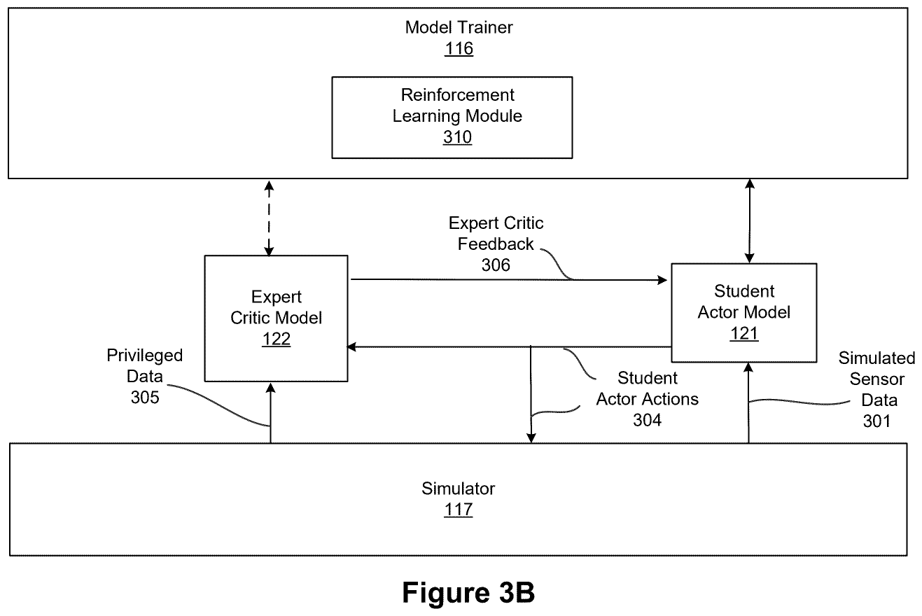

In at least one embodiment, the model trainer 116 is configured to train one or more machine learning models using simulator 117, including but not limited to expert actor model 118, expert critic model 122, and student actor model 121. In such cases, student actor model 121 is trained to generate actions for a robot 160 to perform a task based on a goal and sensor data acquired via one or more sensors 180ᵢ (referred to herein collectively as sensors 180 and individually as a sensor 180). For example, in at least one embodiment, the sensors 180 can include one or more cameras, one or more RGB (red, green, blue) cameras, one or more depth (or stereo) cameras (e.g., cameras using time-of-flight sensors), one or more LiDAR (light detection and ranging) sensors, one or more RADAR sensors, one or more ultrasonic sensors, any combination thereof, etc. Techniques for training expert actor model 118, student actor model 121, and expert critic model 122 using simulator 117, are discussed in greater detail herein in conjunction with at least FIGS. 3A and 3B. Training data and/or trained (or deployed) machine learning models, including student actor model 121 and expert critic model 122, can be stored in the data store 120. In at least one embodiment, the data store 120 can include any storage device or devices, such as fixed disc drive(s), flash drive(s), optical storage, network attached storage (NAS), and/or a storage area-network (SAN). Although shown as accessible over the network 130, in at least one embodiment, the machine learning server 110 can include the data store 120.

As shown, a robot control application 146 that utilizes the trained student actor model 121 is stored in a system memory 144, and executes on one or more processors 142, of the computing device 140. Once trained, student actor model 121 can be deployed, such as via robot control application 146, to control a physical robot in a real-world environment, such as robot 160. In various embodiment, the trained student actor model 121 is deployed for use with virtual environments included in simulator 117, where a virtual model of the robot is simulated within a virtual environment, such as a digital twin or a simulation platform. In the virtual deployment, robot control application 146 interfaces with a virtual representation of robot 160, such as using simulator 117, enabling testing, validation, and refinement of control strategies

As shown, the robot 160 includes multiple links 161, 163, and 165 that are rigid members, as well as joints 162, 164, and 166 that are movable components that can be actuated to cause relative motion between adjacent links. In addition, the robot 160 includes multiple fingers 168ᵢ (referred to herein collectively as fingers 168 and individually as a finger 168) that can be controlled to grip an object. For example, in at least one embodiment, the robot 160 may include a locked wrist and multiple (e.g., four) fingers. Although an example robot 160 is shown for illustrative purposes, in at least one embodiment, techniques disclosed herein can be applied to control any suitable robot.

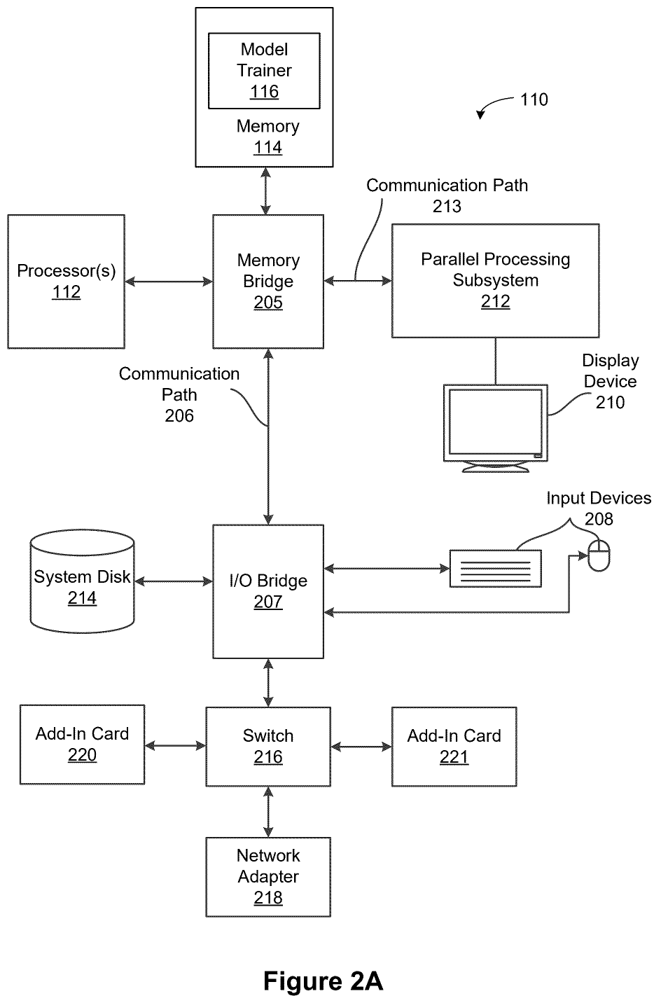

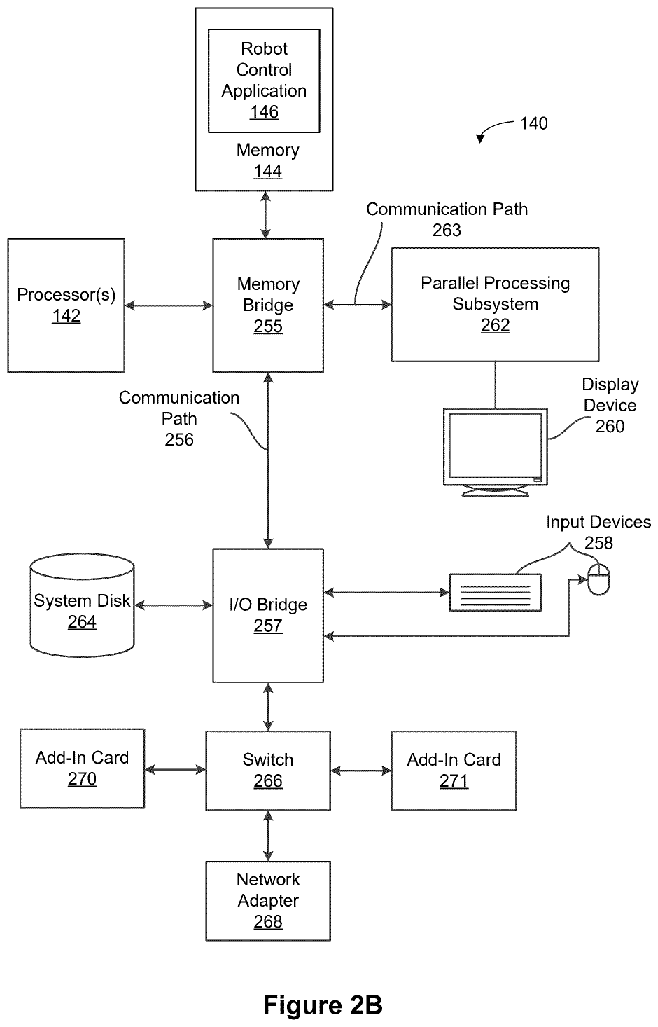

FIG. 2A is a more detailed illustration of the machine learning server 110 of FIG. 1, according to various embodiments. The machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In at least one embodiment, the machine learning server 110 is a server machine operating in a data center or a cloud computing environment that provides scalable computing resources as a service over a network.

In some embodiments, the machine learning server 110 includes, without limitation, the processor(s) 112 and the memory (ies) 114 coupled to a parallel processing subsystem 212 via a memory bridge 205 and a communication path 213. The memory bridge 205 is further coupled to an I/O (input/output) bridge 207 via a communication path 206, and I/O bridge 207 is, in turn, coupled to a switch 216.

In one embodiment, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In at least one embodiment, the machine learning server 110 may be a server machine in a cloud computing environment. In such embodiments, the machine learning server 110 may not include input devices 208, but may receive equivalent input information by receiving commands (e.g., responsive to one or more inputs from a remote computing device) in the form of messages transmitted over a network and received via the network adapter 218. In at least one embodiment, the switch 216 is configured to provide connections between I/O bridge 207 and other components of the machine learning server 110, such as a network adapter 218 and various add-in cards 220 and 221.

In at least one embodiment, the I/O bridge 207 is coupled to a system disk 214 that may be configured to store content and applications and data for use by the processor(s) 112 and the parallel processing subsystem 212. In one embodiment, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In some embodiments, other components, such as universal serial bus or other port connections, compact disc drives, digital versatile disc drives, film recording devices, and the like, may be connected to the I/O bridge 207 as well.

In some embodiments, the memory bridge 205 may be a Northbridge chip, and the I/O bridge 207 may be a Southbridge chip. In addition, the communication paths 206 and 213, as well as other communication paths within the machine learning server 110, may be implemented using any technically suitable protocols, including, without limitation, AGP (Accelerated Graphics Port), HyperTransport, or any other bus or point-to-point communication protocol known in the art.

In at least one embodiment, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry.

In at least one embodiment, the parallel processing subsystem 212 incorporates circuitry optimized (e.g., that undergoes optimization) for general purpose and/or compute processing. The system memory 114 includes at least one device driver configured to manage the processing operations of one or more parallel processing units (PPUs) within the parallel processing subsystem 212. In addition, the system memory 114 includes the model trainer 116. Although described herein with respect to the model trainer 116, techniques disclosed herein can also be implemented, either entirely or in part, in other software and/or hardware, such as in the parallel processing subsystem 212.

In some embodiments, the parallel processing subsystem 212 may be integrated with one or more of the other elements of FIG. 1 to form a single system. For example, the parallel processing subsystem 212 may be integrated with processor 112 and other connection circuitry on a single chip to form a system on a chip (SoC).

In at least one embodiment, the processor(s) 112 includes the primary processor of machine learning server 110, controlling and coordinating operations of other system components. In at least one embodiment, the processor(s) 112 issues commands that control the operation of PPUs. In at least one embodiment, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 112, and the number of parallel processing subsystems 212, may be modified as desired. For example, in at least one embodiment, system memory 114 could be connected to the processor(s) 112 directly rather than through the memory bridge 205, and other devices may communicate with the system memory 114 via the memory bridge 205 and the processor 112. In other embodiments, the parallel processing subsystem 212 may be connected to the I/O bridge 207 or directly to the processor 112, rather than to the memory bridge 205. In still other embodiments, the I/O bridge 207 and the memory bridge 205 may be integrated into a single chip instead of existing as one or more discrete devices. In certain embodiments, one or more components shown in FIG. 1 may not be present. For example, the switch 216 could be eliminated, and the network adapter 218 and the add-in cards 220, 221 would connect directly to the I/O bridge 207. Lastly, in certain embodiments, one or more components shown in FIG. 1 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B is a more detailed illustration of the computing device 140 of FIG. 1, according to various embodiments. The computing device 140 may include any type of computing system, including, without limitation, a server machine, a server platform, a desktop machine, a laptop machine, a hand-held/mobile device, a digital kiosk, an in-vehicle infotainment system, and/or a wearable device. In at least one embodiment, the computing device 140 is a server machine operating in a data center or a cloud computing environment that provides scalable computing resources as a service over a network.

In some embodiments, the computing device 140 includes, without limitation, the processor(s) 142 and the memory (ies) 144 coupled to a parallel processing subsystem 262 via a memory bridge 255 and a communication path 263. The memory bridge 255 is further coupled to an I/O (input/output) bridge 257 via a communication path 256, and I/O bridge 257 is, in turn, coupled to a switch 266.

In one embodiment, the I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In at least one embodiment, the computing device 140 may be a server machine in a cloud computing environment. In such embodiments, the computing device 140 may not include input devices 258, but may receive equivalent input information by receiving commands (e.g., responsive to one or more inputs from a remote computing device) in the form of messages transmitted over a network and received via the network adapter 268. In at least one embodiment, the switch 266 is configured to provide connections between I/O bridge 267 and other components of the computing device 140, such as a network adapter 268 and various add-in cards 270 and 271.

In at least one embodiment, the I/O bridge 257 is coupled to a system disk 264 that may be configured to store content and applications and data for use by the processor(s) 142 and the parallel processing subsystem 262. In one embodiment, the system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In some embodiments, other components, such as universal serial bus or other port connections, compact disc drives, digital versatile disc drives, film recording devices, and the like, may be connected to the I/O bridge 257 as well.

In some embodiments, the memory bridge 255 may be a Northbridge chip, and the I/O bridge 257 may be a Southbridge chip. In addition, the communication paths 256 and 263, as well as other communication paths within the computing device 140, may be implemented using any technically suitable protocols, including, without limitation, AGP (Accelerated Graphics Port), HyperTransport, or any other bus or point-to-point communication protocol known in the art.

In at least one embodiment, the parallel processing subsystem 262 comprises a graphics subsystem that delivers pixels to an optional display device 260 that may be any conventional cathode ray tube, liquid crystal display, light-emitting diode display, and/or the like. In such embodiments, the parallel processing subsystem 262 may incorporate circuitry optimized for graphics and video processing, including, for example, video output circuitry.

In at least one embodiment, the parallel processing subsystem 262 incorporates circuitry optimized (e.g., that undergoes optimization) for general purpose and/or compute processing. The system memory 114 includes at least one device driver configured to manage the processing operations of one or more parallel processing units (PPUs) within the parallel processing subsystem 212. In addition, the system memory 114 includes the robot control application 146. Although described herein with respect to the robot control application 146, techniques disclosed herein can also be implemented, either entirely or in part, in other software and/or hardware, such as in the parallel processing subsystem 262.

In some embodiments, the parallel processing subsystem 262 may be integrated with one or more of the other elements of FIG. 1 to form a single system. For example, the parallel processing subsystem 262 may be integrated with processor 142 and other connection circuitry on a single chip to form a system on a chip (SoC).

In at least one embodiment, the processor(s) 142 includes the primary processor of computing device 140, controlling and coordinating operations of other system components. In at least one embodiment, communication path 263 is a PCI Express link. In at least one embodiment, the processor(s) 142 issues commands that control the operation of PPUs. In at least one embodiment, communication path 163 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 142, and the number of parallel processing subsystems 262, may be modified as desired. For example, in at least one embodiment, system memory 144 could be connected to the processor(s) 142 directly rather than through the memory bridge 255, and other devices may communicate with the system memory 144 via the memory bridge 255 and the processor 142. In other embodiments, the parallel processing subsystem 262 may be connected to the I/O bridge 257 or directly to the processor 142, rather than to the memory bridge 255. In still other embodiments, the I/O bridge 257 and the memory bridge 255 may be integrated into a single chip instead of existing as one or more discrete devices. In certain embodiments, one or more components shown in FIG. 1 may not be present. For example, the switch 266 could be eliminated, and the network adapter 268 and the add-in cards 279 and 271 would connect directly to the I/O bridge 257. Lastly, in certain embodiments, one or more components shown in FIG. 1 may be implemented as virtualized resources in a virtual computing environment, such as a cloud computing environment. In particular, the parallel processing subsystem 262 may be implemented as a virtualized parallel processing subsystem in at least one embodiment. For example, the parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Student Actor Models for Robot Control

FIG. 3A is a more detailed illustration of the model trainer 116 of FIG. 1 training expert critic model 122 and expert actor model 118, according to various embodiments. In some embodiments, model trainer 116 performs a two-step training process. In the first step, shown in FIG. 3A, model trainer 116 trains low-dimensional expert actor model 118 and expert critic model 122 using privileged data 302, which includes low-dimensional state information from simulator 117 that may not be available in real-world scenarios. In the second step, which is described in conjunction with FIG. 3B, model trainer 116 trains high-dimensional student actor model 121 using feedback from the trained expert critic model 122 from the first step and simulated sensor data that replicates real-world conditions generated by simulator 117, which can include higher dimensional data than privileged data, i.e., the simulated sensor data includes data associated with one or more different and/or additional sensor modalities than the privileged data 302. In some embodiments, during the second step, model trainer 116 optionally retrains expert critic model 122 along with student actor model 121 based on a new set of privileged data generated by simulator 117. The two-step training process addresses exploration challenges in high-dimensional policy learning by leveraging the prior knowledge of expert critic model 122 learning during the first training step to provide efficient guidance for learning high-dimensional student actor model 121 during the second training step.

As shown in FIG. 3A, model trainer 116 includes, without limitation, a reinforcement learning module 310. In some embodiments, model trainer 116 uses reinforcement learning module 310 in interaction with simulator 117 to train expert critic model 122 and expert actor model 118.

Simulator 117 provides a virtual environment which processes robot actions, such as actions output by expert actor model 118 or student actor model 121, and generates privileged data and simulated sensor data, which is higher dimensional than the privileged data. Privileged data 302 can include detailed state information about the environment and/or robot 160, such as exact object positions, velocities, joint positions and orientations, pairwise net contact forces between bodies, internal states, and/or the like, which are typically not available in real-world applications due to sensor limitations but can be obtained from simulator 117. For example, simulator 117 could provide exact measurements of contact forces at each point of interaction between a robotic manipulator and an object, as well as the precise positions and velocities of all objects in the environment. Additionally, simulator 117 generates simulated sensor data, which can replicate the real-world data that robot sensors 180 capture during actual deployment and, therefore, be associated with one or more different and/or additional sensor modalities than the privileged data 302. Simulated sensor data can include visual data from virtual cameras, such as RGB images, depth images, and/or the like, and tactile data from virtual sensors embedded in robotic grippers or arms and/or the like. In some embodiments, simulator 117 can simulate various sensor factors such as lighting variations, noise, sensor inaccuracies, and/or the like, to ensure that the generated simulated sensor data is as realistic as possible. For example, in the case of a visuotactile sensor, simulator 117 could simulate both the tactile feedback from the contact between a sensor and objects as well as the associated visual images of the deformation of the sensor surface. The tactile data can include details such as normal and shear forces at each contact point. In some embodiments, simulator 117 includes dynamic physics-based models, such as the Kelvin-Voigt model and/or the like, to simulate soft contacts and deformations, which can be used for accurately replicating real-world interactions between robot 160 and the environment. The dynamic physics-based models simulate how soft sensors and objects deform under applied forces, taking into account properties such as stiffness, damping, and separation velocity. Furthermore, simulator 117 can apply, for each simulated episode, domain randomization techniques, such as physical parameter randomization, tactile image augmentation, color randomization, and/or the like, to mimic real-world sensor data. For example, for visuotactile sensors, simulator 117 could introduce image augmentation by spatially randomizing camera positions and/or zoom operations; adjusting color and/or lighting conditions, such as randomizing brightness, contrast, saturation, hue, and/or order of color channels; and/or varying intrinsic and extrinsic camera parameters to include variations in sensor data, such as differences in camera placement and/or lighting, which are common in real-world scenarios. By generating both privileged data and simulated sensor data, simulator 117 allows the robot control system to bridge the sim-to-real gap, ensuring that the machine learning models trained in simulation can generalize well to real-world deployments. In some embodiments, simulator 117 runs multiple parallel simulation environments, which allows for efficient data collection by generating various experiences across different robot tasks simultaneously.

Expert actor model 118 is a machine learning model, such as a neural network, which processes low-dimensional privileged data 302 to generate an expert actor action 303 (e.g., an action for the robot to execute in simulator 117). Expert actor actions 303 are generated at each time step and specify robot motion for the next period of time (e.g., a fraction of a second) to perform at least part of a task. Expert actor actions 303 can include commands such as adjusting the movement direction, speed, or internal configurations of robot 160 to manipulate an object, move toward a specific location, or adjust joint angles for a short period of time in the future. At each subsequent time step, new actions are generated based on updated privileged data 302, allowing robot 160 to continually adapt behavior over sequential intervals. In some embodiments, model trainer 116 trains the expert actor model 118 in interaction with expert critic model 122 and simulator 117 so that expert actor actions maximize a cumulative reward over time. In some examples, expert actor model 118 includes a long-term-short-term (LSTM) network and a multi-layer perceptron (MLP).

Expert critic model 122 is a machine learning model, such as a neural network, which processes low-dimensional privileged data 302 from simulator 117 and an action generated by an actor model, such as expert actor model 118 or student actor model 121, and generates expert critic feedback. For example, if an actor model generates a robot action for the robot 160 to grasp an object with a specific force and position, expert critic model 122 could evaluate the resulting state of robot 160 and the object, such as whether the object was successfully grasped and moved without slipping. In some embodiments, during training, expert critic model 122 evaluates the actions generated by an actor model, such as expert actor model 118 or student actor model 121, by estimating the value of the resulting state, which represents the expected future rewards if the actor model continues to follow the current policy. For example, if the robot task is to place an object in a specific location, expert critic model 122 could estimate how close the object is to the target and how stable the grip of robot 160 is, projecting the long-term outcome if robot 160 continues along the current trajectory. In some embodiments, expert critic model 122 generates expert critic feedback in the form of value estimates, advantage values, and/or the like, which indicate how good or bad a particular action was in comparison to other possible actions. Model trainer 116 uses expert critic feedback to update the actor models, improving the robot control capabilities of the actor models over multiple iterations of training.

In some embodiments, reinforcement learning module 116 models the robotic task, such as contact-rich manipulation and/or the like, as a Markov decision process (MDP), represented by the tuple ( [symbol] , ρ₀, [symbol] , R, [symbol] , γ), where [symbol] is the state space, representing the full state of the robot 160 and environment included in privileged data 302, ρ₀ is the initial state distribution, describing the probability distribution over the starting states, [symbol] is the action space, including of all possible actions the robot 160 can take, R(s, a, s′) is the reward function, which assigns a scalar reward when transitioning from state s to state s′ by taking action a, [symbol] (s′|s, a) is the transition distribution, describing the probability of reaching state s′ after taking action a in state s, and γ∈[0,1) is the discount factor (e.g., γ=0.99), determining the importance of future rewards. In some embodiments, the goal of the reinforcement learning module 310 is to find a policy π_{θ}_{_{actor}}, where the policy maps the system's states s∈ [symbol] , such as sensor data, to actions a∈ [symbol] that maximize the expected cumulative reward:

$${G}_{t} = {{π}_{θ}}_{} [ {\sum }_{k = 0}^{∞} {γ}^{k} R ( {s}_{t + k} , {a}_{t + k} , {s}_{t + k + 1} ) ] . \qquad ( Equation 1 )$$

In some embodiments, in order to train expert critic model 122 and expert actor model 118, at t=0 with t being the iteration index, model trainer 116 initializes the parameters of expert critic model 122 and expert actor model 118 randomly and simulator 117 generates random privileged data 302 s₀. Then, expert actor model 118, parameterized by θ_{actor}, generates expert actor actions 303 aₜ=π_{θ}_{_{actor}} (sₜ), which is applied in the simulation environment included in simulator 117. Simulator 117 processes student expert actions 303 and generates privileged data 302 sₜ₊₁. Expert critic model 122, parameterized by θ_{critic}, evaluates expert actor actions 303 by estimating a value function V_{θ}_{_{critic}} (sₜ₊₁), which is the expected cumulative reward starting from state sₜ₊₁. In some embodiments, expert critic model 122 estimates the advantage function A_{θ}_{_{critic}} (sₜ, aₜ), which measures the relative quality of an expert actor action 303 aₜ compared to the average performance of expert actor actions 303 in that state:

$${A}_{{θ}_{critic}} ( {s}_{t} , {a}_{t} ) = {Q}_{{θ}_{critic}} ( {s}_{t} , {a}_{t} ) - {V}_{{θ}_{critic}} ( {s}_{t} ) , \qquad ( Equation 2 )$$

where Q_{θ}_{_{critic}} (sₜ, aₜ) is the action-value function. Expert critic model 122 processes both privileged data 302 and expert actor actions 303 to generate expert critic feedback that is used to update expert actor model 118 and expert critic model 122. Subsequently, reinforcement learning module 310 optimizes the policy π_{θ}_{_{actor}} using expert critic feedback. In some examples, reinforcement learning module 310 maximize the expected reward in Equation 1 by updating the parameters θ_{actor} of expert actor model 118 based on the evaluation of expert critic model 122 of the actions (e.g., expert critic feedback). For example, reinforcement learning module 310 can minimize a loss function, often related to the advantage function in Equation 2 or the value function V_{θ}_{_{critic}} (sₜ). Reinforcement learning module 310 adjusts the parameters of expert actor model 118 to improve the performance of expert actor model 118 over time. In some examples, reinforcement learning module 310 can use the Temporal Difference (TD) error, which compares the predicted value V_{θ}_{_{critic}} (sₜ) to the observed reward and the value of the next state:

$${δ}_{t} = {r}_{t} + γ {V}_{{θ}_{critic}} ( {s}_{t + 1} ) - {v}_{{θ}_{critic}} ( {s}_{t} ) , \qquad ( Equation 3 )$$

where rₜ=R(sₜ, aₜ, sₜ₊₁) is the instantaneous reward at time step t. In some robotic manipulation examples, the instantaneous reward for training expert actor model 118 and expert critic model 122 is given as rₜₐₛₖ=r_{keypoint}−r_{action}−r_{contact}, where r_{keypoint} is the distance between keypoints centered on the peg and the keypoints of the target pose on the placement pad or socket, r_{action} is a penalty applied to the policy action, discouraging unnecessary or inefficient movements, and r_{contact} is a penalty on the contact forces between the peg and the environment, including the socket, table, and other interacting surfaces. Reinforcement learning module 310 updates the parameters θ_{critic} of expert critic model 122 to reduce the TD error in Equation 3, improving the ability of expert critic model 122 to evaluate expert actor model 118 accurately based on privileged data 302 and expert actor actions 303. For example, reinforcement learning module 310 can minimize the critic's loss function (e.g., the Bellman loss) which is defined as:

$${L}^{critic} ( {θ}_{critic} ) = {t}_{} [ {δ}_{t}^{2} ] . \qquad ( Equation 4 )$$

In some embodiments, reinforcement learning module 310 iteratively updates both the expert actor model 118 and the expert critic model 122. For example, the parameters of expert actor model 118 θ_{actor} can be updated as follows:

$${θ}_{a c t o r} ← {θ}_{a c t o r} + {α}_{actor} {∇}_{{θ}_{a c t o r}} {G}_{t} , \qquad ( Equation 5 )$$

where α_{actor} is the learning rate for the expert actor model 118 and ∇θ_{actor} is the gradient of the expected cumulative reward in Equation 1 with respect to the parameters θ_{actor}. Similarly, the parameters θ_{critic} of expert critic model 122 can be updated to minimize the TD error:

$${θ}_{critic} ← {θ}_{critic} - {α}_{critic} {∇}_{{θ}_{c r i t i c}} {L}^{critic} ( {θ}_{critic} ) , \qquad ( Equation 6 )$$

where α_{critic} is the learning rate for training expert critic model 122. In some embodiments, reinforcement learning module 310 uses the Proximal Policy Optimization (PPO) technique to train expert actor model 118. In PPO, the objective function to be maximized is:

$${L}^{P P O} ( {θ}_{a c t o r} ) = {𝔼}_{t} [ min ( {r}_{t} ( {θ}_{actor} ) {\hat{A}}_{t} , clip ( {r}_{t} ( {θ}_{actor} ) , 1 - ϵ , 1 + ϵ ) {\hat{A}}_{t} ) ] , \qquad ( Equation 7 )$$

where

$${r}_{t} ( {θ}_{actor} ) = \frac{{π}_{{θ}_{a c t o r}} ( {a}_{t} \vert {s}_{t} )}{{π}_{{θ}_{a c t o r}^{old}} ( {a}_{t} \vert {s}_{t} )}$$

is the probability ratio between the new policy and the old where policy for action aₜ and ϵ is a hyperparameter that controls how much the policy is allowed to change in each update step (e.g., ϵ=2). Âₜ is the generalized advantage estimate provided by the expert critic model 122, which measures how much better the action aₜ is compared to other actions as given by Equation 2 given by

$${\hat{A}}_{t} = {\sum }_{l = 0}^{∞} {( γ λ )}^{l} {δ}_{t + l} , \qquad ( Equation 8 )$$

where the parameter λ (e.g., λ=0.95) helps in achieving smoother and more stable training. The clipping mechanism ensures that the policy update does not change too much in one step, preventing instability during training. The parameters θ_{actor} of expert actor model 118 are updated by performing gradient ascent on the objective function in Equation 7:

$${θ}_{actor} ← {θ}_{actor} + {α}_{actor} {∇}_{{θ}_{a c t o r}} {L}^{P P O} ( {θ}_{actor} ) , \qquad ( Equation 9 )$$

where ∇θ_{actor} L^{PPO} (θ_{actor}) is the gradient of the PPO objective function in Equation 7 with respect to the parameters of expert actor model 118. The gradient of the PPO objective function is computed as:

$${∇}_{{θ}_{a c t o r}} {L}^{P P O} ( {θ}_{actor} ) = {t}_{} [ {∇}_{{θ}_{a c t o r}} log {π}_{{θ}_{a c t o r}} ( {a}_{t} \vert {s}_{t} ) {\hat{A}}_{t} ] , \qquad ( Equation 10 )$$

where log π_{θ}_{_{actor}} (aₜ|sₜ) is the log-probability of the action at under the policy π_{θ}_{_{actor}}. In some embodiments, model trainer 116 trains both expert critic model 122 and expert actor model 118 iteratively until a stopping criterion is met, such as reaching a maximum number of iterations, a plateauing loss function, and/or the like. Once the training of expert critic model 122 and expert actor model 118 is complete, model trainer 116 stores expert critic model 122 in data store 120, or elsewhere.

FIG. 3B is a more detailed illustration of the model trainer 116 of FIG. 1 retraining the expert critic model 122 and training a student actor model 121, according to various embodiments. As shown, model trainer 116 trains student actor model 121 using the trained expert critic model 122 and simulator 117. In some embodiments, model trainer also optionally retrains expert critic model 122 during the training.

Student actor model 121 is a machine learning model, such as a neural network, which processes sensor data and generates student actor actions 304. In some embodiments, student actor model 121 processes noisy, incomplete, and high-dimensional inputs, such as camera images, tactile sensor readings, and/or the like, from sensors 180 to generate student actor actions that allow robot 160 to interact with the environment. For example, in a robotic manipulation task, student actor model 121 could process visual inputs from a camera mounted on a robot arm and tactile data from sensors embedded in a robot gripper. The visual input can include an RGB image of the object to be grasped, while the tactile sensor data provides information about the force applied by the gripper on the object. Student actor model 121 processes the sensor data and generates robot actions, such as adjusting the gripper position or force, to successfully manipulate the object without dropping or damaging the object. During training, student actor model 121 processes simulated sensor data generated by simulator 117 instead of real-world sensor data. In some examples, student actor model 121 includes various types of neural networks, such as a convolutional neural network (CNN) for processing high-dimensional visual inputs, a LSTM network for handling sequential data with temporal dependencies, and a MLP for processing lower-dimensional sensor readings or states.

In some embodiments, reinforcement learning module 310 trains student actor model 121 using expert critic feedback 306 from trained expert critic model 122. In some embodiments, the goal of the reinforcement learning module 310 is to find a policy πθ_{student}, where the policy maps the robot's observations o∈ [symbol] , such as simulated sensor data 301 or sensor data acquired by sensors 180, to actions a∈ [symbol] that maximize an expected cumulative reward, such as the expected cumulative reward in Equation 1. In order to train student actor model 121, at t=0 with t being the iteration index, reinforcement learning module 310 initializes the parameters θ_{student} of student actor model 121 with random values, and simulator 117 generates random simulated sensor data 301 o₀ and privileged data 305 s₀. Student actor model 121 generates student actor actions 304

$${a}_{t} = {π}_{{θ}_{student}} ( {o}_{t} ) ,$$

which is applied in the simulation environment included in simulator 117. Simulator 117 processes student actor actions 304 and generates simulated sensor data 301 oₜ₊₁ and privileged data 305 sₜ₊₁ The trained expert critic model 122 evaluates student actor actions 304 by estimating a value function

$${V}_{{θ}_{critic}} ( {s}_{t + 1} ) ,$$

based on privileged data 305. Expert critic model 122 also computes the advantage function

$${A}_{{θ}_{critic}} ( {s}_{t} , {a}_{t} )$$

as defined in Equation 2 to evaluate how the generated action compares to the average performance of actions in that state. In some embodiments, reinforcement learning module 310 uses the PPO technique to train student actor model 121 and optionally retrain expert critic model 122. Reinforcement learning module 310 uses a loss function such as

$${L}^{actor} ( {θ}_{student} ) = - {t}_{} [ {\hat{A}}_{{θ}_{critic}} ( {s}_{t} , {a}_{t} ) \cdot log {π}_{{θ}_{student}} ( {a}_{t} \vert {o}_{t} ) ] \qquad ( Equation 11 )$$

to optimize the parameters θ_{student} of student actor model 121. Reinforcement learning module 310 then uses an update rule such as

$${θ}_{student} ← {θ}_{student} + {α}_{student} {∇}_{{θ}_{student}} {L}^{actor} ( {θ}_{student} ) \qquad ( Equation 12 )$$

to update the parameters of student actor model 121, where α_{student} is the learning rate for student actor model 121. In some embodiments, reinforcement learning module 310 also optionally updates the parameters of α_{critic} of expert critic model 122 based on a loss function, such as Equation 4, using an update rule, such as Equation 6. In some embodiments, model trainer 116 trains student actor model 121 and optionally retrains expert critic model 122 iteratively until a stopping criterion is met, such as reaching a maximum number of iterations, a plateauing loss function, and/or the like. Once the training of student actor model 121 is complete, model trainer 116 stores expert critic model 122 and student actor model 121 in data store 120, or elsewhere.

In some embodiments, model trainer 116 trains the student actor model 121 and optionally retrains expert critic model 122 using both privileged data 305 and simulated sensor data 301 collected from parallel simulation environments, such as 128 simulation environments, in simulator 117. For example, model trainer 116 can use a mini-batch size of 512, which specifies the number of data samples, such as states, actions, and rewards, processed per training iteration. Each of the 128 simulation environments could contribute four samples, resulting in a mini-batch of 512 samples that model trainer 116 uses to update the student actor model 121. In some embodiments, model trainer 116 uses a technique called ‘Learning Epochs per Training Batch,’ where each mini-batch of data is reused multiple times during training. For example, with four epochs, each batch of privileged data 305 and simulated sensor data 301 is processed up to four times within the same training iteration.

In some embodiments, model trainer 116 can train expert actor model 118, expert critic model 122, and student actor model 121 according to Algorithm 1:

### Algorithm 1: Asymmetric Actor-Critic Distillation

Require: initial low-dim expert actor parameters

$${θ}_{actor}^{0} ,$$

low-dim value function of expert critic parameters ϕₑₓₚₑᵣₜ⁰, and high-dim student actor parameters

$${θ}_{student}^{0} ,$$

Stage 1: Train low-dim expert actor policy πθ_{actor}(s) and value function V_{ϕ}_{ₑₓₚₑᵣₜ}(s)
for n=0 to N do
   Collect rollout data with

$${π}_{{θ}_{a c t o r}^{n}} ( s )$$

Update

$${θ}_{actor}^{n + 1}$$

using PPO objective in Equation 7 and

$${V}_{{ϕ}_{expert}^{n}} ( s )$$

Update

$${ϕ}_{expert}^{n + 1} ,$$

using Bellman loss in Equation 4
end for
Stage 2: Train high-dim policy πθ_{student} (o) and fine-tune V_{ϕ}_{ₑₓₚₑᵣₜ}(s)
for m=0 to M do
   Collect rollout data with

$${π}_{{θ}_{student}^{m}} ( o )$$

Update

$${θ}_{student}^{m + 1}$$

using PPO objective in Equation 11 and

$${V}_{{ϕ}_{expert}^{N + m}} ( s )$$

Update

$${ϕ}_{expert}^{N + m + 1} ,$$

using Bellman loss in Equation 4
end for
Evaluate π_{θ}_{_{student}} and obtain success rate.

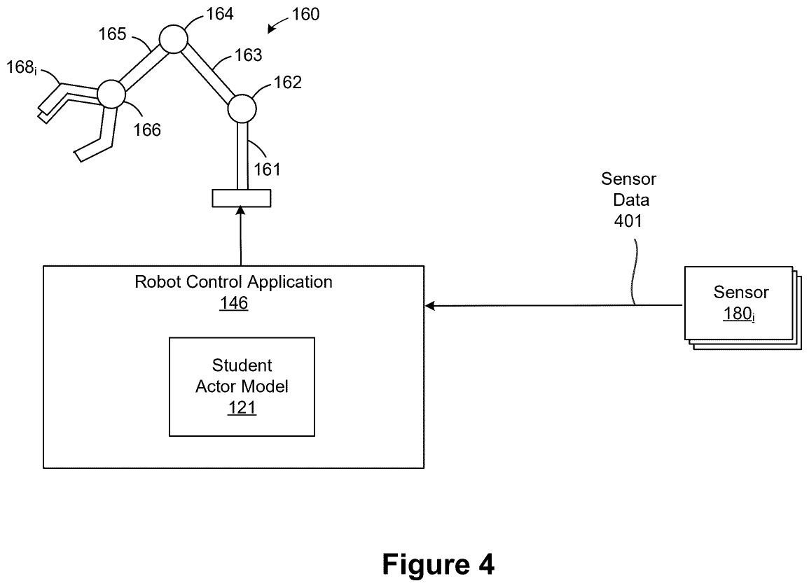

FIG. 4 is a more detailed illustration of the robot control application 146 of FIG. 1, according to various embodiments. As shown, robot control application 146 uses the trained student actor model 121 to process sensor data 401 received from sensors 180 to control robot 160.

In operation, robot control application 146 receives sensor data 401 from sensors 180. Sensor data 401 can include visual data from cameras, tactile feedback from force sensors, joint angles from encoders, position and orientation data from inertial measurement units (IMUs), proximity measurements from LIDAR or ultrasonic sensors, and/or the like. The trained student actor model 121 processes sensor data 401 to generate student actor actions 304 for robot 160 to perform at least part of a task, such as adjusting the position of the robotic arm, modulating grip strength, navigating through an environment, and/or the like. In some embodiments, student actor model 121 makes real-time decisions to optimize task completion performance of robot 160, adapt robot 160 to dynamic environments, and execute at least parts of tasks, such as picking and placing objects, avoiding obstacles, maintaining precise contact during manipulation, and/or the like. In some embodiments, robot control application 146 uses a low-level controller (not shown) to translate the high-level actions generated by the student actor model 121 into specific motor commands or actuator signals. The low-level controllers can include Proportional-Integral-Derivative (PID) controllers, impedance controllers, model predictive controllers, and/or the like, and ensure precise execution of the student actor actions 304 by adjusting joint velocities, positions, and forces of robot 160 in real time.

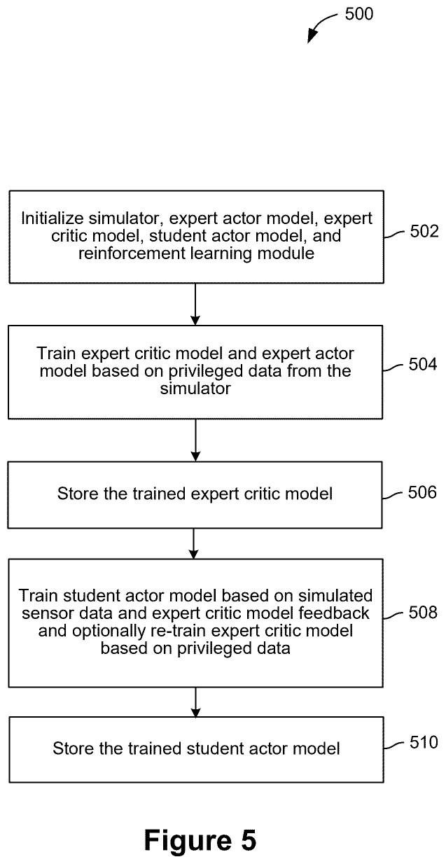

FIG. 5 sets forth a flow diagram of method steps for training student actor model 121, according to various embodiments. Although the method steps are described in conjunction with the systems of FIGS. 1-4, persons skilled in the art will understand that any system configured to perform the method steps in any order falls within the scope of the present disclosure.

As shown, a method 500 begins with step 502, where model trainer 116 initializes simulator 117, expert actor model 118, expert critic model 122, student actor model 121, and reinforcement learning module 310. In some embodiments, simulator 117 is initialized to simulate a robot task as well as various sensors. For example, in some embodiments, simulator 117 can be set up to simulate multiple parallel simulation environments, such as parallel simulation environments executing on different processors (e.g., different GPUs), that generate both privileged data 305 and simulated sensor data 301. Model trainer 116 initializes expert actor model 118, expert critic model 122, and student actor model 121 with random parameters. Model trainer 116 also initializes reinforcement learning module 310, such as setting the discount factor γ, which determines the importance of future rewards as described Equation 1. In some embodiments, model trainer 116 initializes the parameters specific to PPO, such as the clipping parameter ϵ to stabilize policy updates as described in Equation 7, and the GAE parameter λ as described in Equation 8, which balances bias and variance in advantage estimation. Model trainer 116 also initializes the learning rates α_{critic} as described in Equation 6, α_{actor} as described in Equations 5 and 9, and α_{student} as described in Equation 12 to control the step sizes for updating the expert critic model 122, expert actor model 118, and student actor model 121, respectively.

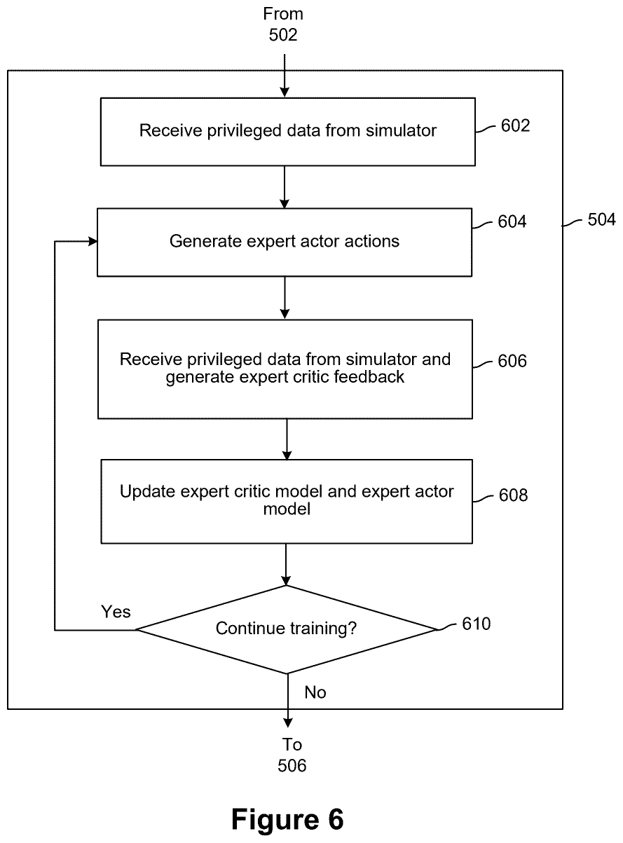

At step 504, model trainer 116 trains expert critic model 122 and expert actor model 118 based on low-dimensional privileged data 302 from the simulator 117. In some embodiments, simulator 117 generates privileged data 302, which expert actor model 118 processes to generate expert actor actions 303. Expert critic model 122 processes privileged data 302 and expert actor actions 303 and generates expert critic feedback. Reinforcement learning module 310 uses the expert critic feedback to iteratively optimize the parameters of expert critic model 122 and expert actor model 118. The method steps for training expert critic model 122 and expert actor model 118 are described in more detail in conjunction with FIG. 6.

At step 506, model trainer 116 stores the trained expert critic model 122. In some embodiments, model trainer 116 can store the trained expert critic model 122 in data store 120 or elsewhere.

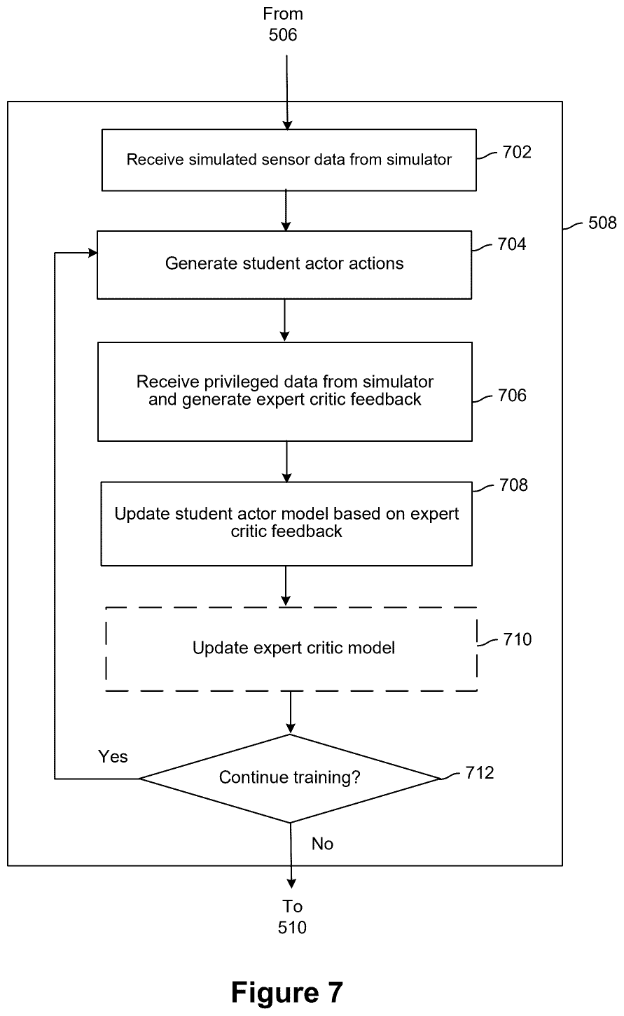

At step 508, model trainer 116 trains (1) student actor model 121 based on simulated sensor data 301, which is higher dimensional and can be associated with one or more different and/or additional sensor modalities than the privileged data, and (2) expert critic model feedback 306 and optionally re-train expert critic model 122 based on privileged data 305. In some embodiments, simulator 117 generates privileged data 305 and simulated sensor data 301. Student expert actor model 121 processes simulated sensor data 301 and generates student actor actions 304. Expert critic model 122 that has been trained according to step 504 processes privileged data 305 and student actor actions 304 and generates expert critic feedback 306. Reinforcement learning module 310 uses expert critic feedback 306 to iteratively optimize the parameters of student actor model 121. In some embodiments, model trainer 116 also optionally retrains expert critic model 122 by optimizing parameters thereof. The method steps for retraining expert critic model 122 and student actor model 121 are described in more detail in conjunction with FIG. 7.

At step 510, model trainer 116 stores the trained student actor model 121. In some embodiments, model trainer 116 can store the trained student actor model 121 in data store 120 or elsewhere.

FIG. 6 sets forth a flow diagram of method steps for training expert critic model 122 and expert actor model 118 at step 504 of method 500, according to various embodiments. Although the method steps are described in conjunction with the systems of FIGS. 1-4, persons skilled in the art will understand that any system configured to perform the method steps in any order falls within the scope of the present disclosure.

As shown at step 602, expert actor model 118 receives privileged data 302 from simulator 117. In some embodiments, simulator 117 generates random privileged data 302, which includes current state of robot 160 and the environment.

At step 604, expert actor model 118 generates expert actor actions 303. In some embodiments, expert actor model 118 processes privileged data 302 from simulator 117 to generate expert actor actions 303. Expert actor actions 303 are applied to robot 160 in simulator 117, for example, causing robot 160 to perform at least part of a task. Simulator 117 simulates robot 160 and the environment, moving to the next state.

At step 606, expert critic model 122 receives privileged data 302 from simulator 117. In some embodiments, expert critic model 122 receives the state of robot 160 and the environment after an expert actor action 303 is applied. In some embodiments, expert critic model 122 evaluates expert actor actions 303 by estimating a value function, an advantage function such as the advantage function described in Equation 2, and/or the like. Expert critic model 122 processes both privileged data 302 and expert actor actions 303 to generate expert critic feedback.

At step 608, reinforcement learning module 301 updates expert critic model 122 and expert actor model 118. In some embodiments, reinforcement learning module 310 maximizes the expected reward in Equation 1 by updating the parameters of expert actor model 118 based on the expert critic feedback. For example, in some embodiments, reinforcement learning module 310 minimizes a loss function related to the advantage function in Equation 2 or the value function. In some embodiments, reinforcement learning module 310 updates the parameters of expert critic model 122 to reduce the TD error described in Equation 3 based on the loss function in Equation 4. In some embodiments, reinforcement learning module 310 iteratively updates both the expert actor model 118 and the expert critic model 122 using an update rule, for example, the update rules described in Equation 5 and Equation 6. In some embodiments, reinforcement learning module 310 uses the PPO technique to train expert actor model 118 using the loss function described in Equation 7 and the update rule in Equation 9.

At step 610, model trainer 610 checks whether to continue training. In some embodiments, model trainer 116 checks whether a stopping criterion is met, such as reaching a maximum number of iterations, a plateauing loss function, and/or the like. If the stopping criterion is met, method 500 proceeds to step 506. If the stopping criterion is not met, method 500 returns to step 604.

FIG. 7 sets forth a flow diagram of method steps for training student actor model 121 and retraining expert critic model 122 at step 508 of method 500, according to various embodiments. Although the method steps are described in conjunction with the systems of FIGS. 1-4, persons skilled in the art will understand that any system configured to perform the method steps in any order falls within the scope of the present disclosure.

As shown, at step 702, where student actor model 121 receives simulated sensor data 301 from simulator 117. In some embodiments, simulator 117 generates simulated sensor data 302 randomly.

At step 704, student actor model 121 generates student actor actions 304. In some embodiments, student actor model 121 processes simulated sensor data 302 and generates student actor actions 304, which are applied to robot 160 in simulator 117, causing robot 160 to perform at least part of a task. Simulator 117 simulates robot 160 and the environment, moving to the next state included in privileged data 305.

At step 706, expert critic model 122 receives privileged data 305 from simulator 117 and generates expert critic feedback 306. In some embodiments, expert critic model 122 receives the state of robot 160 and the environment after an student actor action 304 is applied. In some embodiments, expert critic model 122 evaluates student actor actions 304 by estimating a value function, an advantage function such as the advantage function described in Equation 2, and/or the like. Expert critic model 122 processes both privileged data 305 and student actor actions 304 to generate expert critic feedback 306.

At step 708, reinforcement learning module 301 updates student actor model 121 based on expert critic feedback 306. In some embodiments, the goal of the reinforcement learning module 310 is to find a policy, mapping the observations of robot 160, such as simulated sensor data 301 or sensor data acquired by sensors 180, to actions that maximize an expected cumulative reward, such as the expected cumulative reward in Equation 1. In some embodiments, reinforcement learning module 310 uses the PPO technique to train student actor model 121 using a PPO loss function, such as the loss function in Equation 11. Reinforcement learning module 310 then uses an update rule, such as the update rule in Equation 12, to update the parameters of student actor model 121.

At optional step 710, reinforcement learning module 301 updates expert critic model 122. In some embodiments, reinforcement learning module 310 updates the parameters of expert critic model 122 using a loss function, such as Equation 4, and using an update rule, such as Equation 6.

At step 712, model trainer 116 checks whether to continue training. In some embodiments, model trainer 116 checks whether a stopping criterion is met, such as reaching a maximum number of iterations, a plateauing loss function, and/or the like. If the stopping criterion is met, method 500 proceeds to step 510. If the stopping criterion is not met, method 500 returns to step 704.

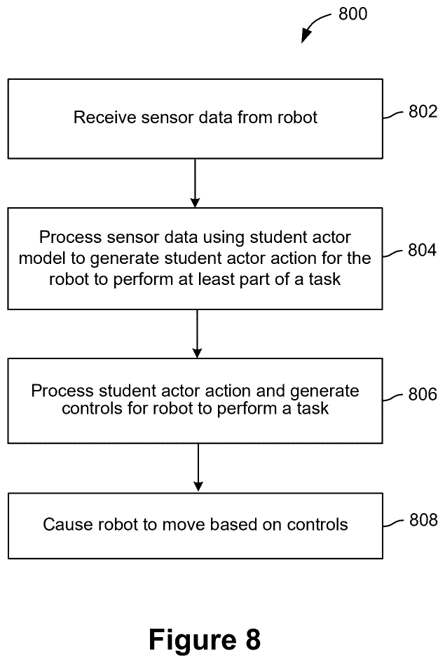

FIG. 8 sets forth a flow diagram of method steps for controlling robot 160 using the trained student actor model 121, according to various embodiments. Although the method steps are described in conjunction with the systems of FIGS. 1-4, persons skilled in the art will understand that any system configured to perform the method steps in any order falls within the scope of the present disclosure.

The method 800 begins with step 802, where robot control application 146 receives sensor data 401. In some embodiments, robot control application 146 receives sensor data 401 from sensors 180 on robot 160, described above in conjunction with FIG. 1.

At step 804, robot control application 146 processes sensor data 401 using student actor model 121 to generate student actor action 304 for the robot 160 to perform at least part of a task. In some embodiments, the trained student actor model 121 processes sensor data 401 to generate student actor actions 304 for robot 160 to perform at least part of a task. In some embodiments, student actor model 121 makes real-time decisions to optimize task completion performance of robot 160, adapt robot 160 to dynamic environments, and execute at least parts of tasks.

At step 806, robot control application 146 processes student actor action 304 and generates controls for robot 160 to perform a task. In some embodiments, robot control application 146 can use a low-level controller to translate the high-level actions generated by the student actor model 121 into specific motor commands or actuator signals for robot 160. In some other embodiments, robot control application 146 can transmit the student actor action 304 to another controller that generates the specific motor commands or actuator signals for robot 160.

At step 808, robot control application 146 causes robot 160 to move based on the controls. In some embodiments, robot control application 146 applies controls generated at step 806 to adjust joint velocities, positions, and/or forces of robot 160 in real time.

In sum, techniques are disclosed for robot control using student actor models that are trained with pre-trained critic models. The disclosed techniques include training a student actor model using an actor-critic reinforcement learning framework in a two-stage process. In the first stage, an expert actor model and an expert critic model are trained using privileged data, such as exact object positions, forces, velocities, contact points, and/or the like, from a simulator. The expert actor model is a machine learning model that processes privileged data to generate robot actions, while the expert critic model evaluates the actions and provides feedback to improve the actions generated by the expert actor model. Once the expert critic model and the expert actor models are trained, the student actor model, which is another machine learning model that processes sensor data, such as visual inputs from cameras, tactile data from touch sensors, and/or the like, and generates robot actions, is trained using simulated sensor data and feedback from the expert critic model. The disclosed techniques also include an option to retrain the expert critic model during training of the student actor model training. After training, the student actor model can be deployed to control a robot by processing real-world sensor inputs and generating robot actions to perform tasks.

At least one technical advantage of the disclosed techniques relative to prior art is that, with the disclosed techniques, robots can be effectively controlled based on high-dimensional data from various sources, such as visual, tactile, and/or position data. Another advantage of the disclosed techniques is that using reinforcement learning approaches, such as PPO, and using the privileged data from the simulator, the disclosed techniques enable faster training of machine learning models to control robots. These technical advantages provide one or more technological improvements over prior art approaches.

1. In some embodiments, a computer-implemented method for training a machine learning model to control a robot comprises performing, based on a first set of data, one or more training operations to generate a first trained machine learning model to control a robot and a trained evaluation model, and performing, based on a second set of data and first feedback generated by the trained evaluation model, one or more training operations to generate a second trained machine learning model to control the robot, wherein the second set of data is associated with a different set of sensor modalities than the first set of data.

2. The computer-implemented method of clause 1, further comprising performing, based on the second set of data and a third set of data, one or more training operations on the trained evaluation model to generate a re-trained evaluation model.

3. The computer-implemented method of clauses 1 or 2, wherein performing one or more training operations to generate the first trained machine learning model and the trained evaluation model comprises processing the first set of data using an untrained machine learning model to generate an action, processing the first set of data and the action using an untrained evaluation model to generate second feedback, updating one or more parameters of the untrained machine learning model based on the second feedback and the first set of data, and updating one or more parameters of the untrained evaluation model based on the first set of data and the action.

4. The method of any of clauses 1-3, wherein updating the one or more parameters of the untrained machine learning model comprises minimizing a Bellman loss.

5. The method of any of clauses 1-4, wherein updating the one or more parameters of the untrained machine learning model comprises estimating a generalized advantage, and performing one or more operations to minimize a proximal policy optimization objective function.

6. The computer-implemented method of any of clauses 1-5, wherein performing one or more training operations to generate the second trained machine learning model comprises processing the second set of data using an untrained machine learning model to generate an action, processing a third set of data and the action using the trained evaluation model to generate the first feedback, and updating one or more parameters of the untrained machine learning model based on the first feedback and the second set of data.

7. The computer-implemented method of any of clauses 1-6, wherein updating the one or more parameters of the untrained machine learning model comprises estimating a generalized advantage, and performing one or more operations to minimize a proximal policy optimization objective function.

8. The computer-implemented method of any of clauses 1-7, further comprising updating one or more parameters of the trained evaluation model based on the third set of data and the action.

9. The computer-implemented method of any of clauses 1-8, wherein the first set of data includes privileged data from one or more first simulations, and the second set of data includes sensor data acquired via one or more sensors in one or more second simulations.

10. The computer-implemented method of any of clauses 1-9, wherein the first set of data and the second set of data are generated by a simulator that simulates a virtual environment processing at least one of the first action or the second action, at least one of contacts, deformations, or interactions between the robot and an environment, and a plurality of domain randomization techniques.

11. In some embodiments, one or more non-transitory computer-readable media include instructions that, when executed by one or more processors, cause the one or more processors to perform the steps of performing, based on a first set of data, one or more training operations to generate a first trained machine learning model to control a robot and a trained evaluation model, and performing, based on a second set of data and first feedback generated by the trained evaluation model, one or more training operations to generate a second trained machine learning model to control the robot, wherein the second set of data is associated with a different set of sensor modalities than the first set of data.

12. The one or more non-transitory computer-readable media of clause 11, wherein the instructions, when executed by the one or more processors, further cause the one or more processors to perform the step of performing, based on the second set of data and a third set of data, one or more training operations on the trained evaluation model to generate a re-trained evaluation model.

13. The one or more non-transitory computer-readable media of clauses 11 or 12, wherein the instructions, when executed by the one or more processors, further cause the one or more processors to perform the steps of processing the first set of data using an untrained machine learning model to generate an action, processing the first set of data and the action using an untrained evaluation model to generate second feedback, updating one or more parameters of the untrained machine learning model based on the second feedback and the first set of data, and updating one or more parameters of the untrained evaluation model based on the first set of data and the action.

14. The one or more non-transitory computer-readable media of any of clauses 11-13, wherein updating the one or more parameters of the untrained machine learning model comprises minimizing a Bellman loss.

15. The one or more non-transitory computer-readable media of any of clauses 11-14, wherein the instructions, when executed by the one or more processors, further cause the one or more processors to perform the steps of processing the second set of data using an untrained machine learning model to generate an action, processing a third set of data and the action using the trained evaluation model to generate the first feedback, and updating one or more parameters of the untrained machine learning model based on the first feedback and the second set of data.

16. The one or more non-transitory computer-readable media of any of clauses 11-15, wherein updating the one or more parameters of the untrained machine learning model comprises estimating a generalized advantage, and performing one or more operations to minimize a proximal policy optimization objective function.

17. The one or more non-transitory computer-readable media of any of clauses 11-16, wherein the instructions, when executed by the one or more processors, further cause the one or more processors to perform the step of generating the first feedback by the trained evaluation model by estimating a value function.

18. The one or more non-transitory computer-readable media of any of clauses 11-17, wherein the instructions, when executed by the one or more processors, further cause the one or more processors to perform the step of generating the first feedback by the trained evaluation model by estimating an advantage function.

19. The one or more non-transitory computer-readable media of any of clauses 11-18, wherein the one or more parameters of the untrained machine learning model are updated to minimize a Bellman loss.

20. In some embodiments, a system comprises a memory storing instructions, and a processor that is coupled to the memory and, when executing the instructions, is configured to perform the steps of perform, based on a first set of data, one or more training operations to generate a first trained machine learning model to control a robot and a trained evaluation model, and perform, based on a second set of data and first feedback generated by the trained evaluation model, one or more training operations to generate a second trained machine learning model to control the robot, wherein the second set of data is associated with a different set of sensor modalities than the first set of data.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a machine learning model to control a robot, the method comprising:
performing, based on a first set of data, one or more training operations to generate a first trained machine learning model to control a robot and a trained evaluation model; and
performing, based on a second set of data and first feedback generated by the trained evaluation model, one or more training operations to generate a second trained machine learning model to control the robot, wherein the second set of data is associated with a different set of sensor modalities than the first set of data.

2. The computer-implemented method of claim 1, further comprising performing, based on the second set of data and a third set of data, one or more training operations on the trained evaluation model to generate a re-trained evaluation model.

3. The computer-implemented method of claim 1, wherein performing one or more training operations to generate the first trained machine learning model and the trained evaluation model comprises:
processing the first set of data using an untrained machine learning model to generate an action;
processing the first set of data and the action using an untrained evaluation model to generate second feedback;
updating one or more parameters of the untrained machine learning model based on the second feedback and the first set of data; and
updating one or more parameters of the untrained evaluation model based on the first set of data and the action.

4. The method of claim 3, wherein updating the one or more parameters of the untrained machine learning model comprises minimizing a Bellman loss.

5. The method of claim 3, wherein updating the one or more parameters of the untrained machine learning model comprises:
estimating a generalized advantage; and
performing one or more operations to minimize a proximal policy optimization objective function.

6. The computer-implemented method of claim 1, wherein performing one or more training operations to generate the second trained machine learning model comprises:
processing the second set of data using an untrained machine learning model to generate an action;
processing a third set of data and the action using the trained evaluation model to generate the first feedback; and
updating one or more parameters of the untrained machine learning model based on the first feedback and the second set of data.

7. The computer-implemented method of claim 6, wherein updating the one or more parameters of the untrained machine learning model comprises:
estimating a generalized advantage; and
performing one or more operations to minimize a proximal policy optimization objective function.

8. The computer-implemented method of claim 6, further comprising updating one or more parameters of the trained evaluation model based on the third set of data and the action.

9. The computer-implemented method of claim 1, wherein the first set of data includes privileged data from one or more first simulations, and the second set of data includes sensor data acquired via one or more sensors in one or more second simulations.

10. The computer-implemented method of claim 1, wherein the first set of data and the second set of data are generated by a simulator that simulates:
a virtual environment processing at least one of the first action or the second action;
at least one of contacts, deformations, or interactions between the robot and an environment; and
a plurality of domain randomization techniques.

11. One or more non-transitory computer-readable media including instructions that, when executed by one or more processors, cause the one or more processors to perform the steps of:
performing, based on a first set of data, one or more training operations to generate a first trained machine learning model to control a robot and a trained evaluation model; and
performing, based on a second set of data and first feedback generated by the trained evaluation model, one or more training operations to generate a second trained machine learning model to control the robot, wherein the second set of data is associated with a different set of sensor modalities than the first set of data.

12. The one or more non-transitory computer-readable media of claim 11, wherein the instructions, when executed by the one or more processors, further cause the one or more processors to perform the step of performing, based on the second set of data and a third set of data, one or more training operations on the trained evaluation model to generate a re-trained evaluation model.

13. The one or more non-transitory computer-readable media of claim 11, wherein the instructions, when executed by the one or more processors, further cause the one or more processors to perform the steps of:
processing the first set of data using an untrained machine learning model to generate an action;
processing the first set of data and the action using an untrained evaluation model to generate second feedback;
updating one or more parameters of the untrained machine learning model based on the second feedback and the first set of data; and
updating one or more parameters of the untrained evaluation model based on the first set of data and the action.

14. The one or more non-transitory computer-readable media of claim 13, wherein updating the one or more parameters of the untrained machine learning model comprises minimizing a Bellman loss.

15. The one or more non-transitory computer-readable media of claim 11, wherein the instructions, when executed by the one or more processors, further cause the one or more processors to perform the steps of:
processing the second set of data using an untrained machine learning model to generate an action;
processing a third set of data and the action using the trained evaluation model to generate the first feedback; and
updating one or more parameters of the untrained machine learning model based on the first feedback and the second set of data.

16. The one or more non-transitory computer-readable media of claim 15, wherein updating the one or more parameters of the untrained machine learning model comprises:
estimating a generalized advantage; and
performing one or more operations to minimize a proximal policy optimization objective function.

17. The one or more non-transitory computer-readable media of claim 15, wherein the instructions, when executed by the one or more processors, further cause the one or more processors to perform the step of generating the first feedback by the trained evaluation model by estimating a value function.

18. The one or more non-transitory computer-readable media of claim 15, wherein the instructions, when executed by the one or more processors, further cause the one or more processors to perform the step of generating the first feedback by the trained evaluation model by estimating an advantage function.

19. The one or more non-transitory computer-readable media of claim 15, wherein the one or more parameters of the untrained machine learning model are updated to minimize a Bellman loss.

20. A system comprising:
a memory storing instructions; and
a processor that is coupled to the memory and, when executing the instructions, is configured to perform the steps of:
perform, based on a first set of data, one or more training operations to generate a first trained machine learning model to control a robot and a trained evaluation model, and
perform, based on a second set of data and first feedback generated by the trained evaluation model, one or more training operations to generate a second trained machine learning model to control the robot, wherein the second set of data is associated with a different set of sensor modalities than the first set of data.
